(19) United States
(12) Patent Application Publication
(10) Pub. No.: US 2008/0089305 A1
(43) Pub. Date: Apr. 17, 2008

(54) System and method for broadband mobile access network

(75) Inventors: Zhonghui Yao, Shenzhen (CN); Wenguang Lan, Shenzhen (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Huawei Technologies Co., Ltd., Shenzhen (CN)

(21) Appl. No.: 11/549,539

(22) Filed: Oct. 13, 2006

(51) Int. Cl. H04B 7/216

(52) U.S. Cl. 370/342

(57) ABSTRACT

System and method for providing network access to a mobile terminal includes a network gateway coupled to a first network and a second network, and a network controller coupled to at least one of the first network and the second network and configured to provide one or more functions for the first network. Additionally, the system includes a first access point coupled to the first network and configured to generate a first wireless network according to at least a first network protocol, and a second access point coupled to the first network and configured to generate a second wireless network according to at least a second network protocol. At least one of the first access point and the second access point is configured to communicate with a mobile terminal through the first wireless network or the second wireless network.

### CROSS-REFERENCES TO RELATED APPLICATIONS

This application is related to Chinese Patent Application No. 200410101018.7, filed Dec. 2, 2004, commonly assigned, incorporated by reference herein for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates in general to telecommunication techniques. More particularly, the invention provides a system and method for broadband access network. Merely by way of example, the invention is described as it applies to a mobile user terminal, but it should be recognized that the invention has a broader range of applicability.

At present, broadband wireless technology is developing rapidly. A variety of broadband wireless technologies have emerged in order to meet the needs of wireless LAN (WLAN), wireless metropolitan area network (WMAN), and wireless personal area network (WPAN). Globally, Wireless Fidelity (“Wi-Fi”) compatible products, that are based on the IEEE 802.11 series standards, have become important for Wireless Local Area Network (“WLAN”). Also, Wi-MAX, based on IEEE 802.16 series standards, has gained wide support and participation of the industry. Additionally, service providers are also engaged in in-depth development of operational tests based on broadband wireless technology, for example, the integration of WLAN hot-spot access operation, Bluetooth voice and WLAN voice, metropolitan coverage, and cellular networks.

The development of broadband services from wired to wireless, from fixed to mobile is an important trend. Broadband fixed wired access system includes Data Subscriber Line (xDSL), CABLE, and Local Area Network (LAN). On the other hand, broadband fixed wireless access system deploys wireless connections to replace the wired connections, but the user terminal is still fixed. In contrast, broadband mobile wireless access system provides wireless access to a mobile user terminal, in addition to supporting wireless access for a fixed user terminal.

FIG. 1 shows a conventional architecture of a broadband fixed wired and/or wireless access network. The Broadband Access Server (BAS) is equivalent to the service convergence equipment at the access layer in the user data interface. At the management control interface, the BAS is associated with the correlated back-end Authentication, Authorization, and Accounting Server (“AAA Server”), and is configured to perform access control management of the fixed user terminal. The access control management includes access authentication, security, and fee calculation.

Compared with fixed wired or wireless access, the mobile wireless broadband access still needs to resolve certain technical issues, such as mobile management of the mobile user terminal and wireless resource management. Mobile management, for example, refers to an user's ability to seamlessly switch from one access point (AP) coverage area to the neighboring AP coverage area, while maintaining operation continuity with no interruptions. Wireless resource management often involves cellular wireless network configuration parameters and wireless resource management allocation for wireless continuous coverage. For example, the capability of load sharing is important in the area where multiple wireless channels are overlapping. In addition, it often is important to consider the network scalability solution, after the mobile access coverage increases. There are a number of conventional techniques that attempt to resolve wireless resource management issues that WLAN networks have encountered. There are at least two conventional solutions: the communication mechanism between the AP and centralized control, and the management framework.

FIG. 2 shows a conventional architecture of a mobile broadband wireless access architecture based on Inter-Access Point Protocol (“IAPP”). For example, IEEE 802.11f provides a communication protocol between APs, that is the Inter-Access Point Protocol (“IAPP”) between APs. Based on this protocol, a Mobile Terminal (MT) can switch seamlessly between APs. This method often uses an interactive communication process between APs when one MT is associated with an AP or re-associated with the AP. At the same time, in order to ensure communication security between the APs, a Remote Access Dial-In User Service (“RADIUS”) server is provided for IAPP service. The AP is first registered to a RADIUS server through the RADIUS protocol after the AP is powered on. Through the RADIUS server, the AP can obtain the IP address of its corresponding AP, and carry out communications based on the IP layer. Additionally, the AP can also acquire encrypted communication from the RADIUS server.

FIG. 3 shows another conventional architecture of a mobile broadband wireless access architecture based on Light-Weight AP Protocol (“LWAPP”). In comparison with IAPP, LWAPP provides a centralized control and management framework through some AP functions. In other words, the LWAPP architecture centralizes some functions of the AP Media Access Control (MAC) layer to a higher level switch such as a Wi-Fi switch, or implement these functions at a router such as the Access Router (AR). In more detail, the Control and Provisioning of Wireless Access Point (CAPWAP) working group of the INTERNET ENGINEERING TASK FORCE (IETF) has summarized the WLAN centralized frameworks into three types of MAC processing structures: Remote MAC, SPLIT MAC, and Local MAC and collectively calls the higher level Wi-Fi switch or access router as an Access Controller (AC). As an example, for remote MAC, all MAC functions of the AP are transferred to AC for implementation. In another example, for SPLIT MAC, some MAC functions that are not time-sensitive are implemented by the AC. In yet another example, for Local MAC, the MAC layer functions are still implemented on the AP side, but are subject to AC management control. Often, the Light-Weight AP is considered equivalent to a SPLIT MAC framework.

Hence it is highly desirable to improve techniques for broadband mobile access.

### BRIEF SUMMARY OF THE INVENTION

The present invention relates in general to telecommunication techniques. More particularly, the invention provides a system and method for broadband access network. Merely by way of example, the invention is described as it applies to a mobile user terminal, but it should be recognized that the invention has a broader range of applicability.

According to an embodiment, a system for providing network access to a mobile terminal includes a network gateway coupled to a first network and a second network, and a network controller coupled to at least one of the first network and the second network and configured to provide one or more functions for the first network. Additionally, the system includes a first access point coupled to the first network and configured to generate a first wireless network according to at least a first network protocol, and a second access point coupled to the first network and configured to generate a second wireless network according to at least a second network protocol. At least one of the first access point and the second access point is configured to communicate with a mobile terminal through the first wireless network or the second wireless network. The mobile terminal is associated with a terminal location, and capable of moving with respect to the first access point and the second access point and of switching between the first wireless network and the second wireless network depending on the terminal location. The network gateway is configured to identify at least which one of the first access point and the second access point is configured to communicate with the mobile terminal, and the network controller is configured to determine the first network protocol and the second network protocol, and to assist the mobile terminal switching between the first wireless network and the second wireless network.

According to another embodiment, a method for providing network access to a mobile terminal includes providing a first communication link between a network gateway and a first network and a second communication link between the network gateway and a second network, and providing a third communication link between a network controller and at least one of the first network and the second network. The network controller is configured to provide one or more functions for the first network. Additionally, the method includes establishing a fourth communication link between the first access point and the first network, providing a first wireless network by the first access point according to at least a first network protocol, establishing a fifth communication link between the second access point and the first network, and providing a second wireless network by the second access point according to at least a second network protocol. Moreover, the method includes selecting, by the network gateway, at least one access point from the first access point and the second access point to communicate with a mobile terminal. The mobile terminal is associated with a terminal location and capable of moving with respect to the first access point and the second access point. Also, the method includes establishing a sixth communication link between the mobile terminal and the selected access point. The process of providing a first wireless network by the first access point according to at least a first network protocol includes a process of selecting the first protocol by the network controller from a first plurality of protocols. The first access point is capable of providing the first wireless network according to each of the first plurality of protocols.

Many benefits are achieved by way of the present invention over conventional techniques. Certain embodiments of the present invention provide a broadband mobile access system. For example, the broadband mobile access system includes BMNC and BMAG in accordance with carrier interface and control interface isolation principles. BMAG can provide data routing for IP services, and BMNC can provide QoS control. In another example, the broadband mobile access system provides multiple AP controls using BMNC as the interface core for network control and BMAG as the interface core for data flow routing. In yet another example, the broadband mobile access system also includes an AS, and an NMS for network management. The AS can assist BMNC to complete user authentication and user information management, and NMS can provide network maintenance and human-machine interface. In yet another example, various components of the broadband mobile access system are coordinated to provide a complete IP service for mobile user terminals.

Some embodiments of the present invention provide implementation of broadband mobile access network system through cooperation among various system components, and implementation of network connections between system components and on various layers through VLAN or IP link.

Certain embodiments of the present invention can achieve layer isolation, user isolation, and/or service isolation. Some embodiments of the present invention can provide network coverage through subsections. Certain embodiments of the present invention provide a broadband mobile access method using a broadband mobile access network system. Some embodiments of the present invention provide broadband mobile access network integration with other networks. For example, such integration is accomplished by expanding entity functions and updating protocol support on the MTs. In another example, the specific air interface support is encapsulated in an AP, and the AP can support multiple air interface protocols. In another example, the interface between the AP and other entities remains unchanged. Hence, the access system can select different types of air interface protocols, and the implementation of the entire system is not dependent upon a specific protocol selected.

Some embodiments of the present invention provide a broadband mobile access system that can be easily integrated with the backbone network to make full use of its transmission resources. Certain embodiments of the present invention can expands mobile access network scalability, improves mobile network performance, and/or reduces operating costs. For example, the broadband mobile access system implements data layer isolation, improves network robustness, implements user service isolation, and/or achieves QoS assurance. In another example, the broadband mobile access system facilitates the service provider to expand their services, and enhances the flexibility for upgrading a network. Some embodiments of the present invention provide seamless switching between different wireless channels in the service area for MT to achieve integration of the broadband mobile access network with other networks. For example, such integration is achieved via simple expansion of the functionality of each entity, enhancement of the openness of the broadband mobile access network, and significant enrichment of broadband mobile access services.

Depending upon embodiment, one or more of these benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 shows a conventional architecture of a broadband fixed wired and/or wireless access network;

FIG. 2 shows a conventional architecture of a mobile broadband wireless access architecture based on Inter-Access Point Protocol (“IAPP”);

FIG. 3 shows another conventional architecture of a mobile broadband wireless access architecture based on Light-Weight AP Protocol (“LWAPP”);

FIG. 4 is a simplified diagram showing a broadband mobile access system according to an embodiment of the present invention;

FIGS. 5(a), (b), (c), and (d) show networking conditions between APs, BMNC, and BMAG for control interface services provided by the broadband mobile access system according to certain embodiments of the present invention;

FIGS. 6(a), (b), and (c) show networking conditions for user service data interface provided by the broadband mobile access system according to certain embodiments of the present invention;

FIG. 7 shows wireless coverage provided by the broadband mobile access system according to an embodiment of the present invention;

FIGS. 8(a), (b), (c), and (d) show integration between broadband mobile access network and other networks provided by the broadband mobile access system according to certain embodiments of the present invention;

FIG. 9 is a simplified diagram showing interfaces between entities of the broadband mobile access system according to an embodiment of the present invention.

### DETAILED DESCRIPTION OF THE INVENTION

The present invention relates in general to telecommunication techniques. More particularly, the invention provides a system and method for broadband access network. Merely by way of example, the invention is described as it applies to a mobile user terminal, but it should be recognized that the invention has a broader range of applicability.

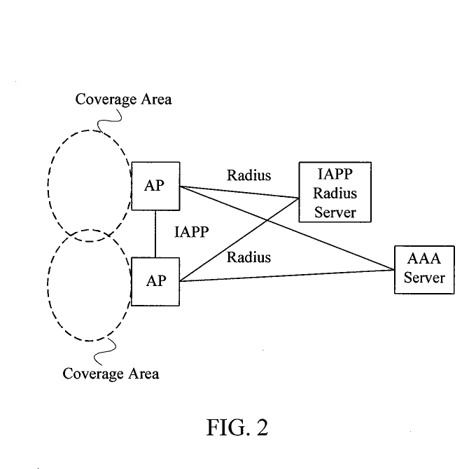

As shown in FIG. 2, almost all important functions for mobile user access control are implemented on the AP. When the network reaches a certain scale, such configuration can restrict network performance and evolution regarding allocation and maintenance of a large number of APs.

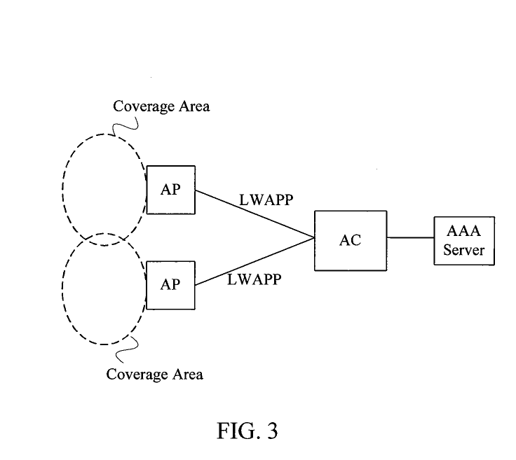

As shown in FIG. 3, the LWAPP-based broadband mobile access system can centralize management and control of AP through AC. Such a system also can fulfill a convergence function at the operational level in order to make the network framework more manageable and expandable. This convergence function resolves certain difficulties for broadband mobile access associated with the access network. But from a long-term perspective, there are still problems with regard to network development, network integration, and the provisioning of IP services

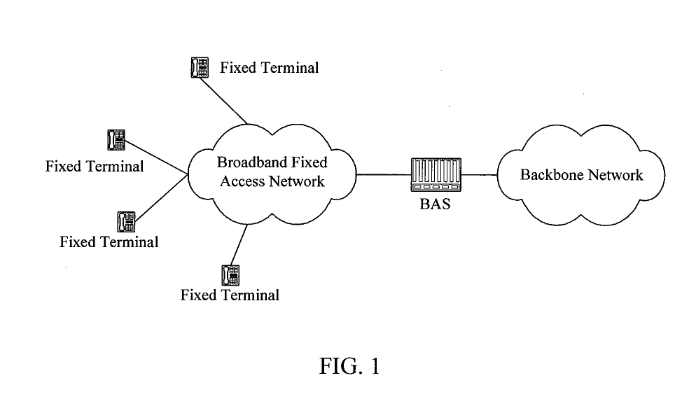

Additionally, as shown in FIGS. 1-3, the conventional techniques often cannot provide a complete networking framework. The expansion of the access network and integration of multiple networks are limited. It is also difficult to improve access performance and provide robust IP services. For example, the conventional techniques are directed at WLAN, thus making the service providers subject to specific wireless technology restrictions. Moreover, these conventional techniques often do not disclose how to use a mobile access network or how to manage network resources.

In real-world applications, the conventional techniques as discussed above usually have one or more problems: restrictions on access network expansion, performance enhancement, and network integration, and overdependence on wireless interface protocols. One cause for these problems is the complexity of the functions to be implemented by the AP in the broadband mobile access system structure based on the IAPP protocol. Such access system structure often can achieve only mobile communications on a small scale, and therefore restrict network expansion. On the other hand, the broadband mobile access system structure based on LWAPP protocol centralizes deployment of control functions by AC. Such access system structure shifts the management functions and the control layer to AC for implementation, which relieves some network expansion pressure. But the access system usually cannot achieve full-blown networking, which can seriously affect network performance and integration. Also, implementation of AC functions usually is related to the specific air interface protocol; therefore, the access network system can be highly dependent on the wireless interface.

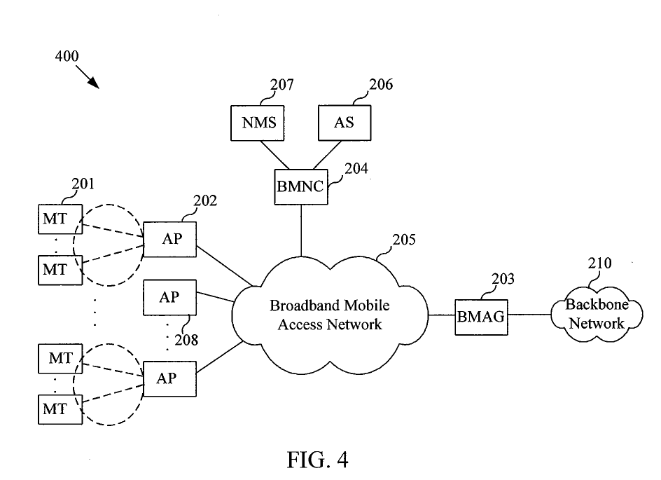

FIG. 4 is a simplified diagram showing a broadband mobile access system according to an embodiment of the present invention. This diagram is merely an example, which should not unduly limit the scope of the claims. One of ordinary skill in the art would recognize many variations, alternatives, and modifications. The system 400 includes at least a Mobile Terminal (MT) 201, Mobile Access Points (APs) 202 and 208, Broadband Mobile Access Gateway (BMAG) 203, a Broadband Mobile Network Controller (BMNC) 204, an Authentication Server (AS) 206, and a Network Management System (NMS) 207. Although the above has been shown using a selected group of apparatuses for the system 400, there can be many alternatives, modifications, and variations. Other apparatuses may be inserted to those noted above. Depending upon the embodiment, the arrangement of apparatuses may be interchanged with others replaced. Further details of these apparatuses are found throughout the present specification and more particularly below.

The system 400 is configured to provide network access to a mobile terminal. In one embodiment, the system 400 includes a network gateway, such as the BMAG 203, that is coupled to a network 205 and a network 210. For example, the network 205 is a broadband mobile access network including wireless and/or wired connections. In another example, the network 210 is a backbone network.

Additionally, the system 400 includes a network controller, such as the BMNC 204, that is coupled to at least one of the network 205 and the network 210, and is configured to provide one or more functions for the network 205. Moreover, the system 400 includes an access point 202 that is coupled to the network 205 and configured to generate a wireless network according to at least a network protocol, and includes another access point 208 that is coupled to the network 205 and configured to generate another wireless network according to at least another network protocol. For example, these two network protocols are the same or different. In another example, each of these two wireless networks includes a broadband wireless network, which is configured to provide a communication speed of at least 2 Mbps.

At least one of the access points 202 and 208 is configured to communicate with a mobile terminal 201 through at least one of the wireless networks. As shown in FIG. 4, the mobile terminal 201 is associated with a terminal location, and capable of moving with respect to the access points 202 and 208 according to an embodiment. For example, depending on the terminal location, the mobile terminal is capable of switching between the wireless networks generated by the network access points 202 and 208. In another example, the mobile terminal 201 includes a cellular phone and/or a computer.

Additionally, according to an embodiment, the network gateway 203 is configured to identify at least which one of the access points 202 and 208 is configured to communicate with the mobile terminal 201. Moreover, the network controller 204 is also configured to determine the network protocols for the wireless networks, and to assist the mobile terminal 201 switching between the wireless networks according to another embodiment. For example, the network controller 204 selects the protocol for the access point 202 from a plurality of protocols, and the access point 202 is capable of providing the wireless network according to each of the plurality of protocols. In one embodiment, the plurality of protocols includes ones determined by IEEE 802.11 series, IEEE 802.15 series, and/or IEEE 802.16 series. In another example, the network controller 204 selects the protocol for the access point 208 from another plurality of protocols, and the access point 208 is capable of providing the wireless network according to each of the another plurality of protocols. In one embodiment, the another plurality of protocols includes ones determined by IEEE 802.11 series, IEEE 802.15 series, and/or IEEE 802.16 series.

According to an embodiment, the MT 201 refers to the user terminal equipment that supports the wireless interface access network provided by the broadband mobile access system. For example, the wireless interface access network may support a hybrid network of multiple types of wireless air interfaces. In another example, an MT may only support one type of wireless interface or support multiple types of wireless interfaces. According to another embodiment, an AP is an access server providing wireless signals to one or more MTs, and the access server includes at least one set of radio frequency transmitting and receiving equipment and the related antenna feeding system. For example, each of the APs 202 and 208 includes at least a wireless transmitter and a wireless receiver. The wireless signals communicating through an AP cover a specific area, and one or more MTs may access the broadband network through this AP in the specific coverage area. For example, the AP 202 and/or the AP 208 supports various types of wireless air interfaces. In another example, IEEE 802.11 series, IEEE 802.15 series, and IEEE 802.16 series are all optional broadband mobile access technologies supported by the AP 202 and/or the AP 208. The APs 202 and 208, controlled by the BMNC 204, completes the MT access control. For example, one AP may support multiple wireless RF channels simultaneously and multiple wireless interface standards simultaneously, and/or cover multiple regions.

As shown in FIG. 4, the BMAG 203 is converging equipment for broadband mobile service users according to an embodiment. For example, the BMAG 203 is used for maintaining IP connectivity between the MT 201 and the BMAG 203. In another example, the BMAG 203, under the control of the BMNC 204, executes related service strategies such as routing and security activities on the IP layer and above the IP layer. In yet another example, the BMAG 203 provides carrier QoS assurance between the AP 201 and the BMAG 203 based on the service or user QoS request. In yet another example, the BMAG 203, under the control of BMNC 204, is capable of supporting the MT switching between different wireless channels, between different coverage areas, or between different APs in order to maintain IP connectivity and related service continuity. In one embodiment, when performing switching between coverage areas, the BMNC 204 detects that wireless signals for a given MT are valid for two APs. In response the BMNC 204 sets up both APs to negotiate through BMAG, and thus establishes switching flow and data conversion relation to carry out seamless switching.

For example, the BMNC 204 is a controller for the access network 205, and configured to transmit and receive control signals. The control signals can be used for wireless resource management, user mobility management, and/or user access control. In one embodiment, the wireless resource management function includes wireless resource allocation and monitoring of the entire area covered by the system 400. For example, after the AP 202 and/or 208 powers on and starts working, the BMNC 204 can download the related wireless resource configuration. In another embodiment, the user mobility management function includes maintaining continuity of IP connectivity and service above the IP layer, when the traveling MT 201 switches between wireless channels and/or between APs. In yet another embodiment, the user access control function includes controlling the completion of AP MAC-layer access at air interface, and/or controlling the completion of the related IP connectivity and associated service based on user authentication.

As shown in FIG. 4, the broadband mobile access network 205 carries communication between various entities according to an embodiment of the present invention. For example, these entities includes some or all of the APs 202 and 208, the BMAG 203, and the BMNC 204. In another example, the access network 205 includes a wired network and/or a wireless network. The wired network can use one or more access technologies such as twisted pair access, coaxial cable access, and/or optical fiber access. The wireless network can use one or more access techniques such as wireless point-to-point, wireless point-to-multipoint, and wireless grid networking.

The AS 206 is, for example, used for processing user access authentication requests and issuing user service control strategies according to the user service attributes. In another example, the AS 206 can also maintain user information and provide downloads to other entities. According to an embodiment, only an MT that has undergone AS authentication can receive IP services. According to another embodiment, the AS 206 can coordinate with other network user authentication servers to establish integrated communication across a plurality of networks.

For example, the NMS 207 can provide maintenance management for the network equipment that is related to broadband mobile access, and also provide corresponding man-machine interfaces. In another example, the NMS 207 can greatly improve network efficiency, and also significantly simplify maintenance and management for network administrators.

According to an embodiment of the present invention, when each of the aforementioned entities are networked through the broadband mobile access network 205, the data user interface service and control interface service are separated. For example, the control interface service is managed by the BMNC 204, which controls each entity through the control interface to maintain network operation. In another example, the data user interface service is related to data flows between APs and between an AP and the BMAG. In one embodiment, the BMAG 203 carries out converging and routing functions under the control of the BMNC 204.

According to another embodiment of the present invention, the broadband mobile access network 205 uses one or more network resources such as Virtual Local Area Network (VLAN) or IP network. During networking, the broadband mobile access network 205 often needs to establish service carrier connections between one or more APs, the BMAG 203, and the BMNC 204. For example, the AP 201 may choose different access modes to access the network. In one embodiment, the AP 201 connects directly with the BMAG 203, and/or connects indirectly with the BMAG 203 and/or the BMNC 204 through the broadband mobile access network 205. To improve management and assurance of the services, certain embodiments of the present invention take into account various types of separations between different services, such as between APs, between MTs, and/or between management control service and MT user carrier service.

As discussed above and further emphasized here, FIG. 4 is merely an example, which should not unduly limit the scope of the claims. One of ordinary skill in the art would recognize many variations, alternatives, and modifications. For example, the system 400 includes a plurality of BMAGs, each of which is similar to the BMAG 203. In another example, the system 400 includes a plurality of BMNCs, each of which is similar to the BMNC 204. In yet another example, the BMNC 204 is connected to the backbone network 210 without going through the broadband mobile access network 205.

In yet another example, the system 400 provides a method for providing network access to a mobile terminal. The method includes providing a first communication link between a network gateway and a first network and a second communication link between the network gateway and a second network, and providing a third communication link between a network controller and at least one of the first network and the second network. The network controller is configured to provide one or more functions for the first network. Additionally, the method includes establishing a fourth communication link between the first access point and the first network, providing a first wireless network by the first access point according to at least a first network protocol, establishing a fifth communication link between the second access point and the first network, and providing a second wireless network by the second access point according to at least a second network protocol. Moreover, the method includes selecting, by the network gateway, at least one access point from the first access point and the second access point to communicate with a mobile terminal. The mobile terminal is associated with a terminal location and capable of moving with respect to the first access point and the second access point. Also, the method includes establishing a sixth communication link between the mobile terminal and the selected access point. The process of providing a first wireless network by the first access point according to at least a first network protocol includes a process of selecting the first protocol by the network controller from a first plurality of protocols. The first access point is capable of providing the first wireless network according to each of the first plurality of protocols.

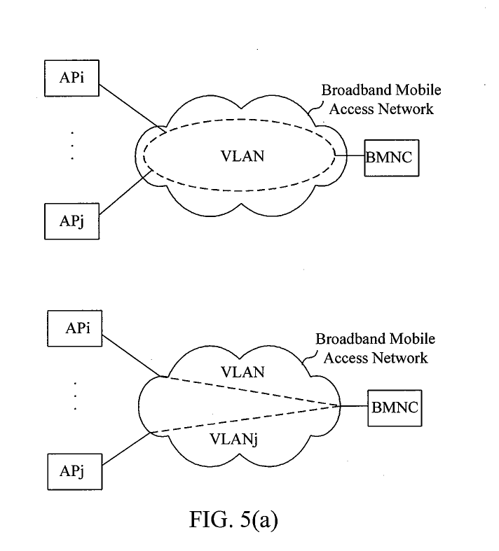

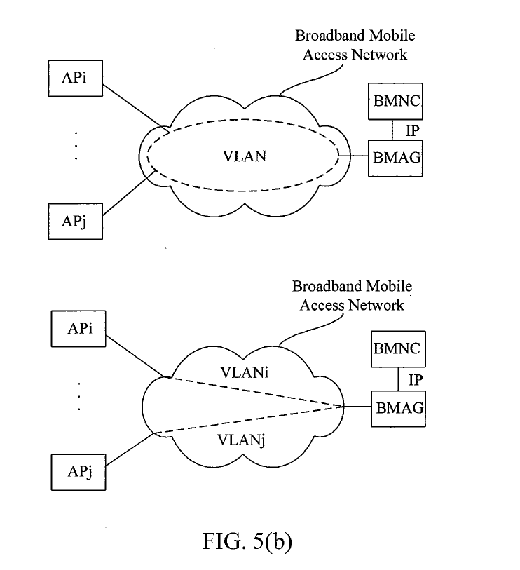

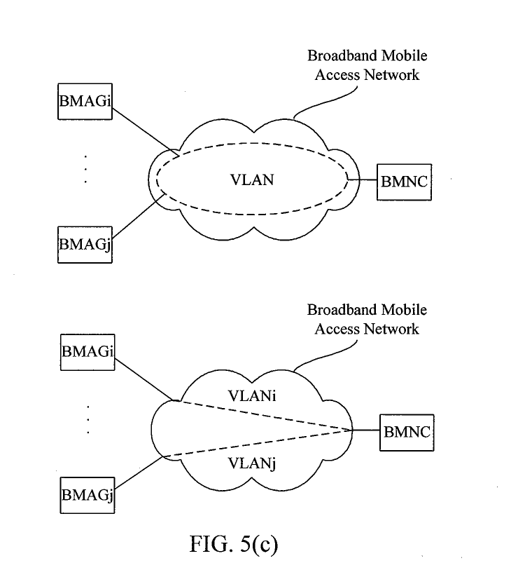

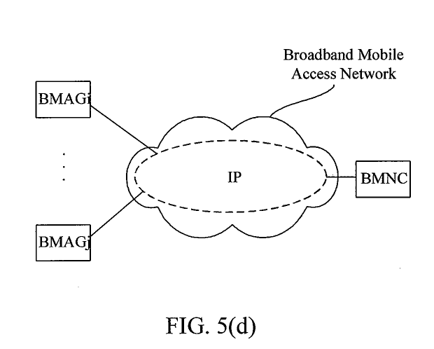

FIGS. 5(a), (b), (c), and (d) show networking conditions between APs, BMNC, and BMAG for control interface services provided by the broadband mobile access system 400 according to certain embodiments of the present invention. These simplified diagrams are merely examples, which should not unduly limit the scope of the claims. One of ordinary skill in the art would recognize many variations, alternatives, and modifications.

FIG. 5(a) shows service networking between AP and BMNC for control interface services based on VLAN according to an embodiment of the present invention. The configuration only requires the broadband mobile access network to support VLAN, and to establish VLAN between the AP and the BMNC. For example, taking into account the requirements of user isolation, service isolation, and others, multiple APs can be networked with a BMNC through one VLAN. In another example, each AP is networked with a BMNC through an independent VLAN, which can achieve isolation between AP services.

FIG. 5(b) shows service networking between AP and BMNC for control interface services based on IP according to another embodiment of the present invention. The configuration uses a BMAG to route IP data to a BMNC. Therefore, networking between the BMAG and the BMNC is via an IP router, and networking between an AP and the BMAG is still through VLAN. For example, taking into account the requirements of user isolation, service isolation, and others, multiple APs are networked with an BMNC through one VLAN. In another example, each AP is networked with a BMAG through an independent VLAN. After the BMAG retransmits IP services to the BMNC, isolation between AP services can be achieved.

FIG. 5(c) shows service networking between BMAG and BMNC for control interface services based on VLAN according to yet another embodiment of the present invention. Similar with the service networking between AP and BMNC, networking between multiple BMAGs and an BMNC is carried out through one or more VLANs. For example, multiple BMAGs are networked with a BMNC through one VLAN without any isolation between BMAG services. In another example, each BMAG is networked with a BMNC through an independent VLAN, which can achieve isolation between BMAG services.

FIG. 5(d) shows service networking between BMAG and BMNC for control interface services based on IP according to yet another embodiment of the present invention. The configuration uses the broadband mobile access network to possess IP routing function. Then IP message communication can be carried out based on BMAG and BMNC IP addresses.

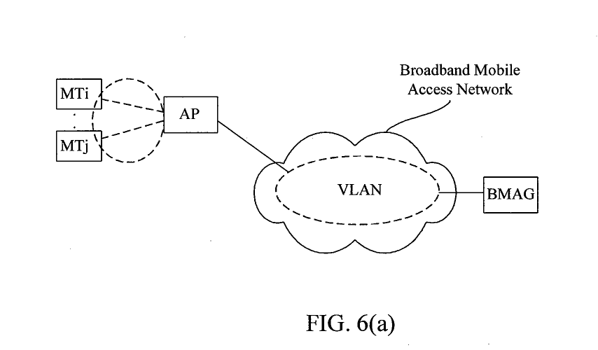

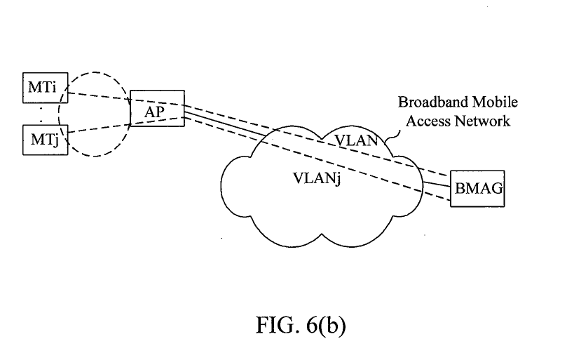

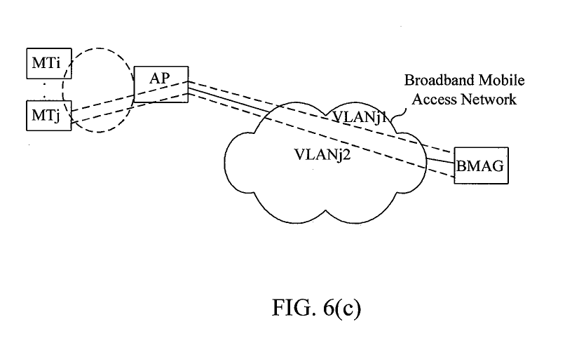

FIGS. 6(a), (b), and (c) show networking conditions for user service data interface provided by the broadband mobile access system 400 according to certain embodiments of the present invention. These simplified diagrams are merely examples, which should not unduly limit the scope of the claims. One of ordinary skill in the art would recognize many variations, alternatives, and modifications.

As shown in FIGS. 6(a), (b), and (c), there are many levels of user service isolation. For example, the user service isolation is isolation of MT user services belonging to different APs, isolation of different MT user services, or isolation of different services of the same MT. The last scenario is the highest level of isolation according to one embodiment.

FIG. 6(a) shows different MTs accessing the same AP are isolated through IP routing. But different AP services are not isolated through different VLANs. FIG. 6(b) shows, after different MTs accessing the same AP, the MTs are connected to a BMAG through different VLANs, in order to achieve isolation between different MT services. FIG. 6(c) shows that different categories of services for the same MT are converged to BMAG through different VLANs after accessing the same AP, in order to achieve isolation between services of different categories.

According to an embodiment, the broadband mobile access system adopts the minimum level of isolation to achieve isolation between user data interface and management control interface, and also adopts the corresponding level of isolation to achieve different degree of QoS assurance for user services. For example, the access system adopts isolation of services of different categories may achieve different QoS assurance according to the service category.

As discussed above and further emphasized here, FIGS. 6(a), (b), and (c) are merely examples, which should not unduly limit the scope of the claims. One of ordinary skill in the art would recognize many variations, alternatives, and modifications. For example, the mode for the broadband mobile access network is not limited to VLAN and IP. Other adequate networking methods can be chosen according to the actual scenario to attain one or more desirable objectives.

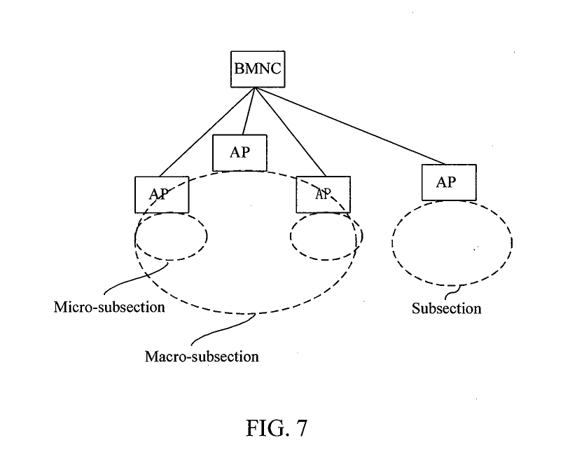

FIG. 7 shows wireless coverage provided by the broadband mobile access system 400 according to an embodiment of the present invention. The simplified diagram is merely an example, which should not unduly limit the scope of the claims. One of ordinary skill in the art would recognize many variations, alternatives, and modifications.

As shown in FIG. 7, taking into account wireless coverage of multiple APs, the wireless coverage provided by the broadband mobile access system is divided into multiple service sections according to the mobile access scale. One BMNC can provide mobile access services to one or multiple service sections simultaneously, and each service section has the corresponding identifier in the system. For example, each service section may be mapped using Service Section Identity (SSID) based on 802.11 series standards. In another example, one service section geologically reflects a relatively large coverage area that includes a set of APs to achieve coverage of that area. A specific implementation of a service section may adopt continuous coverage of multiple APs or non-continuous hotspot coverage.

Additionally, a service section can be divided into many subsections according to an embodiment. One subsection may only contain one wireless channel, or may contain multiple wireless channels. If one subsection includes multiple wireless channels, load sharing is possible between these wireless channels. The overlapping coverage of multiple wireless channels may be provided by the same AP and/or by different APs. Moreover, the configuration as shown in FIG. 7 allows some wireless channels to cover a large area and at the same time also allows other wireless channels to cover some portions of that large area. The coverage of the large area is called a macro-subsection, and the coverage of one or more portions of the large area is called a micro-subsection. As described above, the broadband access network system achieves an independent characteristic with respect to air wireless interface. Therefore, the system is not subject to the restrictions of the wireless air access standards of different subsection coverage. For example, the macro-subsection may adopt IEEE 802.16 series standards, and the micro-subsection may adopt 802.11 series standards.

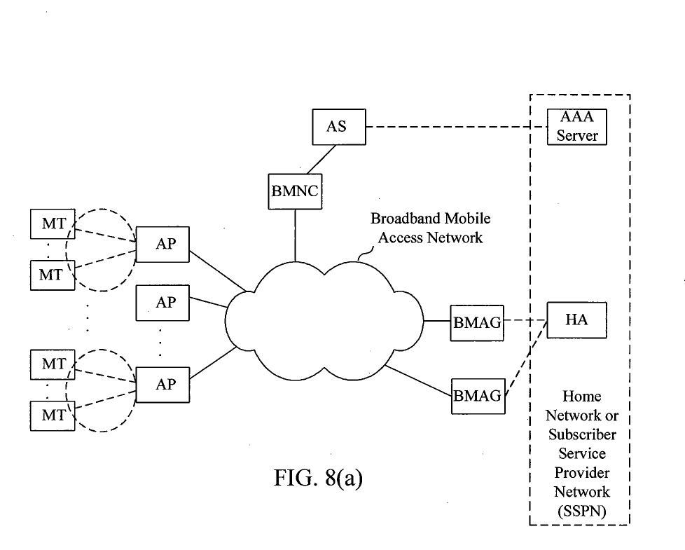

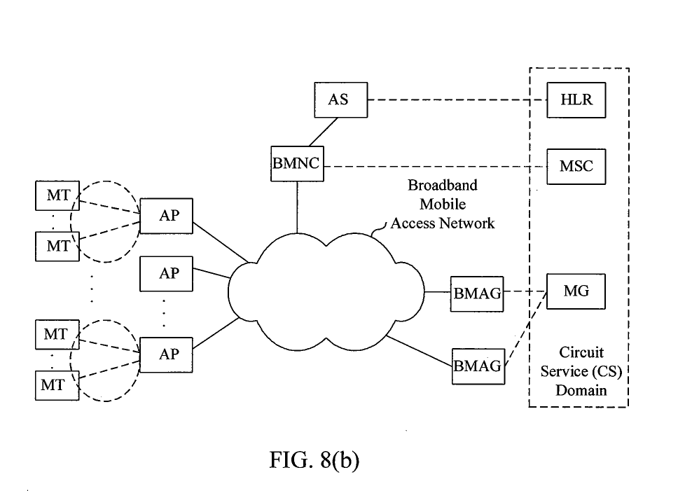

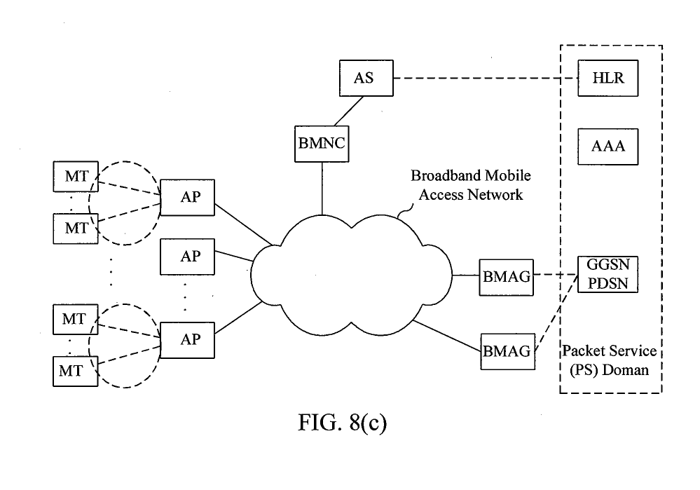

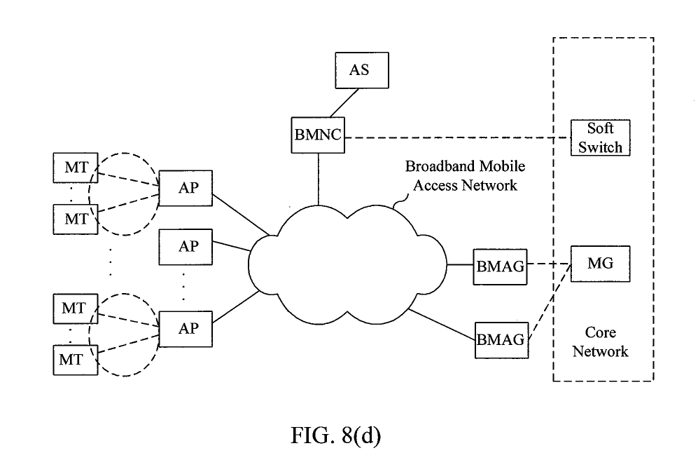

FIGS. 8(a), (b), (c), and (d) show integration between broadband mobile access network and other networks provided by the broadband mobile access system 400 according to certain embodiments of the present invention. These simplified diagrams are merely examples, which should not unduly limit the scope of the claims. One of ordinary skill in the art would recognize many variations, alternatives, and modifications.

FIG. 8(a) shows a network integration proposal utilizing the broadband mobile access network to provide mobile IP services to MT. When an MT requests access to its home network through mobile IP, for example, the intranet, the MT establishes a connection with the home network via the broadband mobile access network as the access point. The BMAG then implements Foreign Agent (FA) for the mobile IP, and one or more IP data packets are routed to the Home Agent (HA). In addition, AS also collaborates with the home AAA server to acquire user information. For example, when switching between different systems, for example, when a MT roaming from General Packet Radio Service (GPRS) to the broadband mobile access network, a guarantee may be requested that the IP address is constant for mobile IP, to ensure service continuity.

FIG. 8(b) shows a proposal for integrating the broadband mobile access network with the mobile network Circuit Service Domain. The switch of the mobile network circuit is the Mobile Switching Center (MSC), which is equivalent to a mobile soft switch. Services for the MT is routed to a Media Gateway (MG) through a BMAG, and in the meantime, the BMNC establishes a mechanism mainly used for QoS assurance. The switching services of the mobile network circuit are voice services, thus from MT to MG is based on IP voice services. At the control interface, the MT has to accomplish switching calling protocol for mobile network circuit, such as 3GPP 24.008 or 04.08.

FIG. 8(c) shows a proposal for integrating the broadband mobile access network with the mobile network Packet Service Domain. The Packet Data Serving Node (PDSN) is the packet data serving node in the Code Division Multiple Access (CDMA) 2000, and the Gateway GPRS Support Node (GGSN) is the gateway serving node of GPRS/Broadband Code Division Multiple Access (WCDMA). Broadband mobile access network may be directly connected to the mobile packet gateway node to directly acquire packet switching service and provide support for seamless switching between different systems. The IP address for MT access is distributed by GGSN or PDSN. For example, an MT is equivalent to two IP addresses, one of which is the access layer IP address which is distributed within the broadband access carrier network. Using the IP address, a virtual connection between MT and GGSN/PDSN can be established. Over this virtual connection, the IP connection between MT and Packet Service (PS) Domain can be established.

FIG. 8(d) shows a proposal for integrating the broadband mobile access network with NGN. Similarly, a BMAG and a MG establish routing relations for processing data flow, and a BMNC and a soft switch establish control relationship. The NGN is applied for voice services, thus, communication from MT to MG is based on IP voice services. In the control interface, the MT has to accomplish NGN calling protocol, such as Session Initiation Protocol (SIP). The BMNC then establishes an access side carrier based on the carrier establishment request of the soft switch mainly for QoS assurance.

According to an embodiment of the present invention, the method for the broadband mobile access network includes three processes:
AP accessing the system: For example, AP and each entity of the broadband mobile access system establishes a communication link;
AP and BMNC establishing connection: For example, BMNC takes over control of AP after collecting AP information and establish wireless coverage for broadband mobile access network;
Under the control of BMNC, one or more BMAGs and APs providing broadband mobile access services to one or more MTs, such as IP services.

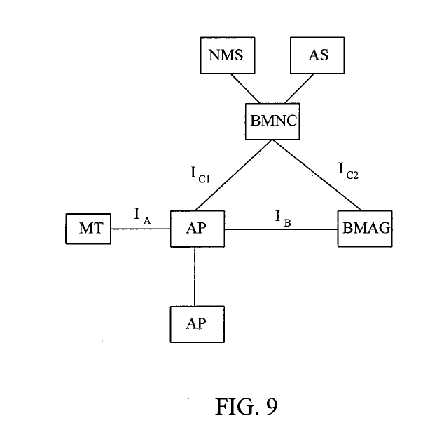

FIG. 9 is a simplified diagram showing interfaces between entities of the broadband mobile access system 400 according to an embodiment of the present invention. This diagram is merely an example, which should not unduly limit the scope of the claims. One of ordinary skill in the art would recognize many variations, alternatives, and modifications.

As shown in FIG. 9, the interface between an MT and an AP is a wireless interface IA. According to one embodiment, the wireless interface IA is established based on one or more protocols, such as the Wireless LAN (WLAN), Wireless Personal Area Network (WPAN), and Wireless Metropolitan Area Network (WMAN) standards. Between the AP and a BMAG there is an interface IB. For example, the interface IB is established based on VLAN and/or IP.

According to an embodiment, for the user data interface, the AP is equivalent to two-layer bridging equipment, which can provide an IP link at network layer between the MT and the BMAG. For example, a VLAN connection between the AP and the BMAG is established through dynamic control or static configuration, and the MT's IP address is dynamically distributed through Dynamic Host Configuration Protocol (DHCP).

According to another embodiment, for the management control interface, there is an interface IC1 between the AP and the BMNC. For example, the interface IC1 is Centralized Control And Management Protocol (CCAMP), which is used for complete access control and related management configuration tasks. In another example, the MT access authentication may adopt one or more techniques such as ones based on IEEE 802.1x standard and WLAN Authentication Infrastructure (WAI) for Wireless Authentication and Privacy Infrastructure (WAPI). In yet another example, the MAC layer management function may be achieved, at least in part, by the AP. Additionally, some frames related to the MAC layer management are processed by the BMNC.

According to yet another embodiment, the CCAMP protocol accomplishes the following functions:
Forwarding one or more frames related to wireless interface MAC layer management to the BMNC for processing in order to achieve centralized access control of the MAC layer;
Forwarding one or more messages such as ones related to 802.1x to the BMNC for processing;
Supporting the BMNC to provide parameters that are relevant to wireless interface MAC layer and physical layer and to dynamically adjust and optimize wireless environment;
Supporting the BMNC to issue one or more policies that are relevant to MAC layer access control, and supporting the AP to report various statistical and warning messages to the BMNC.

According to yet another embodiment, when an MT is switching between different wireless channels, the BMNC performs the switching uniformly. For example, the BMNC processes all MAC switching related frames. In another example, when the MT accesses the AP, the AP reports to the BMNC, which then determines whether or not to switch. Afterwards, the BMNC sends a response to AP about one or more access control policies, such as one related to air interface security.

According to yet another embodiment, a method for an MT to access an AP includes the following processes:
After the MT passes user access authentication, the BMNC provides service parameters to the AP through an interface. For example, the parameters are related to QoS and/or VLAN tag between AP and BMAG;
After the MT completes authentication, the MT sends a message to a DHCP request for an IP address. In response, the AP forwards the DHCP request through the VLAN for the user data interface. The BMAG then responds to the DHCP request, and completes the IP address dynamic distribution.

Returning to FIG. 9, in the management control interface, there is an interface IC2 between the BMAG and the BMNC. For example, the interface IC2 is implemented based on the Gateway Control Protocol (GCP) and carried by VLAN and IP channels. As the converging point for broadband mobile access service, the BMAG needs to manage IP connection for the MT with the assistance from the BMNC. In one embodiment, the BMNC issues certain parameters to the BMAG through the GCP protocol. For example, the parameters include one or more parameters for VLAN tag, one or more parameters for MT access user field, one or more parameters for IP layer service control, and one or more parameters for carrier control such as QoS. In response, the BMAG decides how to distribute the IP address for the MT based on one or more user domain variables.

The present invention has various advantages. Certain embodiments of the present invention provide a broadband mobile access system. For example, the broadband mobile access system includes BMNC and BMAG in accordance with carrier interface and control interface isolation principles. BMAG can provide data routing for IP services, and BMNC can provide QoS control. In another example, the broadband mobile access system provides multiple AP controls using BMNC as the interface core for network control and BMAG as the interface core for data flow routing. In yet another example, the broadband mobile access system also includes an AS, and an NMS for network management. The AS can assist BMNC to complete user authentication and user information management, and NMS can provide network maintenance and human-machine interface. In yet another example, various components of the broadband mobile access system are coordinated to provide a complete IP service for mobile user terminals.

Some embodiments of the present invention provide implementation of broadband mobile access network system through cooperation among various system components, and implementation of network connections between system components and on various layers through VLAN or IP link.

Certain embodiments of the present invention can achieve layer isolation, user isolation, and/or service isolation. Some embodiments of the present invention can provide network coverage through subsections. Certain embodiments of the present invention provide a broadband mobile access method using a broadband mobile access network system. Some embodiments of the present invention provide broadband mobile access network integration with other networks. For example, such integration is accomplished by expanding entity functions and updating protocol support on the MTs. In another example, the specific air interface support is encapsulated in an AP, and the AP can support multiple air interface protocols. In another example, the interface between the AP and other entities remains unchanged. Hence, the access system can select different types of air interface protocols, and the implementation of the entire system is not dependent upon a specific protocol selected.

Some embodiments of the present invention provide a broadband mobile access system that can be easily integrated with the backbone network to make full use of its transmission resources. Certain embodiments of the present invention can expands mobile access network scalability, improves mobile network performance, and/or reduces operating costs. For example, the broadband mobile access system implements data layer isolation, improves network robustness, implements user service isolation, and/or achieves QoS assurance. In another example, the broadband mobile access system facilitates the service provider to expand their services, and enhances the flexibility for upgrading a network. Some embodiments of the present invention provide seamless switching between different wireless channels in the service area for MT to achieve integration of the broadband mobile access network with other networks. For example, such integration is achieved via simple expansion of the functionality of each entity, enhancement of the openness of the broadband mobile access network, and significant enrichment of broadband mobile access services.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A system for providing network access to a mobile terminal, the system comprising:
a network gateway coupled to a first network and a second network;
a network controller coupled to at least one of the first network and the second network and configured to provide one or more functions for the first network;
a first access point coupled to the first network and configured to generate a first wireless network according to at least a first network protocol;
a second access point coupled to the first network and configured to generate a second wireless network according to at least a second network protocol;
wherein:
at least one of the first access point and the second access point is configured to communicate with a mobile terminal through the first wireless network or the second wireless network;
the mobile terminal is associated with a terminal location, and capable of moving with respect to the first access point and the second access point and of switching between the first wireless network and the second wireless network depending on the terminal location;
the network gateway is configured to identify at least which one of the first access point and the second access point is configured to communicate with the mobile terminal;
the network controller is configured to determine the first network protocol and the second network protocol, and to assist the mobile terminal switching between the first wireless network and the second wireless network.

2. The system of claim 1 wherein the first protocol and the second protocol are different.

3. The system of claim 1 wherein the first protocol and the second protocol are the same.

4. The system of claim 1 wherein each of the first wireless network and the second wireless network is a broadband wireless network.

5. The system of claim 4 wherein the broadband wireless network is configured to provide a communication speed of at least 2 Mbps.

6. The system of claim 1 wherein the network controller is configured to selected the first protocol from a first plurality of protocols, the first access point being capable of providing the first wireless network according to each of the first plurality of protocols.

7. The system of claim 6 wherein the first plurality of protocols includes ones determined by IEEE 802.11 series, IEEE 802.15 series, and/or IEEE 802.16 series.

8. The system of claim 1 wherein the network controller is configured to selected the second protocol from a second plurality of protocols, the second access point being capable of providing the second wireless network according to each of the second plurality of protocols.

9. The system of claim 8 wherein the second plurality of protocols includes ones determined by IEEE 802.11 series, IEEE 802.15 series, and/or IEEE 802.16 series.

10. The system of claim 1 wherein:
the first network is an access network;
the second network is a backbone network.

11. The system of claim 10 wherein the access network is a wireless access network or a wired access network.

12. The system of claim 1 wherein each of the first access point and the second access point includes a wireless transmitter and a wireless receiver.

13. The system of claim 1 wherein the mobile terminal includes at least one selected from a group consisting of a cellular phone and a computer.

14. The system of claim 1 wherein the network gateway is a BMAG.

15. The system of claim 1 wherein the network controller is a BMNC.

16. A method for providing network access to a mobile terminal, the method comprising:
providing a first communication link between a network gateway and a first network and a second communication link between the network gateway and a second network;
providing a third communication link between a network controller and at least one of the first network and the second network, the network controller being configured to provide one or more functions for the first network;
establishing a fourth communication link between the first access point and the first network;
providing a first wireless network by the first access point according to at least a first network protocol;
establishing a fifth communication link between the second access point and the first network;
providing a second wireless network by the second access point according to at least a second network protocol;
selecting, by the network gateway, at least one access point from the first access point and the second access point to communicate with a mobile terminal, the mobile terminal being associated with a terminal location and capable of moving with respect to the first access point and the second access point;
establishing a sixth communication link between the mobile terminal and the selected access point;
wherein the providing a first wireless network by the first access point according to at least a first network protocol includes selecting the first protocol by the network controller from a first plurality of protocols, the first access point being capable of providing the first wireless network according to each of the first plurality of protocols.

17. The method of claim 16 wherein the first plurality of protocols includes ones determined by IEEE 802.11 series, IEEE 802.15 series, and/or IEEE 802.16 series.

18. The method of claim 16 wherein the providing a second wireless network by the second access point according to at least a second network protocol includes selecting the second protocol by the network controller from a second plurality of protocols, the second access point being capable of providing the second wireless network according to each of the second plurality of protocols.

19. The method of claim 18 wherein the second plurality of protocols includes ones determined by IEEE 802.11 series, IEEE 802.15 series, and/or IEEE 802.16 series.

20. The method of claim 16 wherein the first protocol and the second protocol are different.

21. The method of claim 16 wherein the first protocol and the second protocol are the same.

22. The method of claim 16 wherein each of the first wireless network and the second wireless network is a broadband wireless network.

23. The method of claim 22 wherein the broadband wireless network is configured to provide a communication speed of at least 2 Mbps.

24. The method of claim 16 wherein:
the first network is an access network;
the second network is a backbone network.

25. The method of claim 24 wherein the access network is a wireless access network or a wired access network.

26. The method of claim 16 wherein the network gateway is a BMAG.

27. The method of claim 16 wherein the network controller is a BMNC.
